(19) United States
(12) Patent Application Publication
(10) Pub. No.: US 2016/0134982 A1
(43) Pub. Date: May 12, 2016

(54) SYSTEM AND METHOD FOR ESTIMATING THE DISPLACEMENT OF A SPEAKER CONE

(71) Applicant: HARMAN INTERNATIONAL INDUSTRIES, INC., Stamford, CT (US)

(72) Inventor: Ajay IYER, Murray, UT (US)

(21) Appl. No.: 14/539,245

(22) Filed: Nov. 12, 2014

(51) Int. Cl. H04R 29/00

(52) U.S. Cl. CPC H04R 29/001

(57) ABSTRACT

A displacement estimation system for estimating cone displacement of a loudspeaker may include an electrical circuit including at least one non-linear component being coupled to a mechanical circuit including at least one non-linear component, and a controller programmed to determine the cone displacement of the loudspeaker based on the at least one non-linear component by using a discrete domain transfer function of a measured current of the electrical circuit, and transmit the displacement to a corrector to correct distortion of an audio signal due to the displacement.

### TECHNICAL FIELD

Embodiments disclosed herein generally relate to a system and method for estimating the displacement of a speaker cone.

### BACKGROUND

Loudspeakers may be electromechanical transducers that produce sound in response to an electronic input signal. Traditional loudspeakers may be housed within a frame and may include a speaker cone and a voice coil centered therein. When an electrical voltage is applied across the ends of a voice coil, an electrical current may be produced which in turn may interact with the magnetic fields to create movement of the speaker cone. An audio waveform may be applied to the voice coil causing the transducer cone to produce sound pressure waves corresponding to the electronic input signal. The extent of this movement may create displacement between the cone and the frame.

### SUMMARY

A displacement estimation system for estimating cone displacement of a loudspeaker may include an electrical circuit including at least one non-linear component being coupled to a mechanical circuit including at least one non-linear component, and a controller programmed to determine the cone displacement of the loudspeaker based on the at least one non-linear component by using a discrete domain transfer function of a measured current of the electrical circuit, and transmit the displacement to a corrector to correct distortion of an audio signal due to the displacement.

An audio system may include a loudspeaker including a cone and a parameter model; and a controller electrically coupled to the loudspeaker and being programmed to determine a cone displacement of the cone based on at least one non-linear component of a speaker model using a discrete domain transfer function of a measured current of the speaker model.

A displacement estimation system for estimating cone displacement of a loudspeaker may include a controller programmed to determine the cone displacement of the loudspeaker based on at least one non-linear component by using a discrete domain transfer function of a measured current of an electrical circuit of a speaker model, wherein the displacement is transmitted to a corrector to correct distortion of an audio signal due to the displacement.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 is a perspective, cross-sectional view of a transducer;

FIG. 2 is a cross-sectional view of the transducer of FIG. 1;

FIG. 3 is a lumped parameter model for the transducer of FIGS. 1 and 2;

FIG. 4 is a block diagram of a displacement estimation system; and

FIG. 5 is an audio system of the displacement estimation system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

During the operation of a loudspeaker, the current carrying voice coil may cause the speaker cone to move and be displaced from the cone's rest position. The movement of the speaker cone may cause air in front of the cone to move thereby producing sound waves. The electromechanical properties of the loudspeaker may change nonlinearly with the displacement of the cone. Thus, large displacements of the speaker cone from the cone's rest position may alter the electromechanical properties of the loudspeaker substantially thereby producing nonlinear audio distortion. The nonlinear audio distortion may result in deterioration of the audio quality. Knowledge of the displacement of the speaker cone may be used to develop nonlinear speaker correctors that reduce the nonlinear distortion. In order to effectively develop such correctors, it may be necessary to estimate the cone displacement. Mechanisms for estimating the displacement may include digital signal processing (DSP). Such processing may use simple linear models. However, for large displacements, the nonlinearities inherent in the loudspeaker may become dominant and thus cause linear models to be inaccurate. The displacement of the cone may also be measured, for example, by using a laser to measure the movement of the cone. However, the use of lasers to determine displacement may be expensive. Described herein is a system and method configured to estimate the displacement of a transducer cone via but not limited to a current of the transducer as well as various nonlinear variables. These variables may represent the suspension stiffness, voice coil inductance, voice coil para-inductance, voice coil para-resistance and force factor of a transducer. By using these variables to attribute the voice coil current to the displacement of the speaker cone, a reliable system and method for estimating the cone displacement may be implemented. The estimated displacement may then be used to develop an adaptive non-linear corrector.

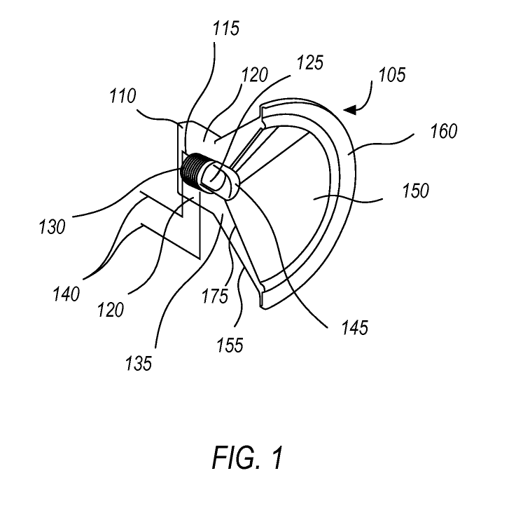

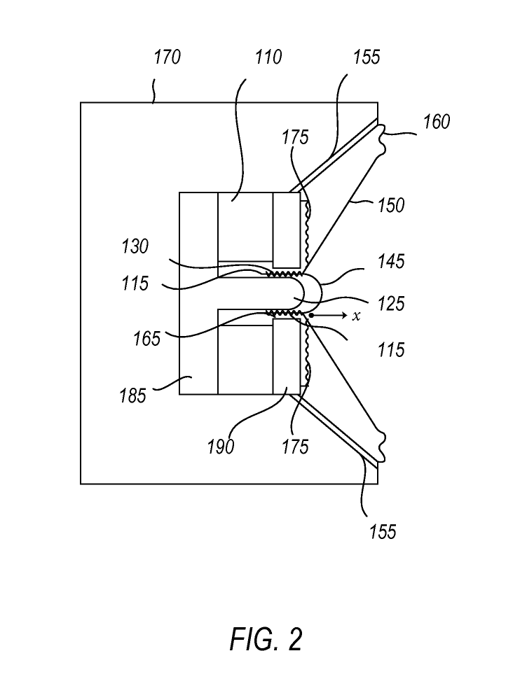

FIGS. 1 and 2 show a loudspeaker 105. FIG. 1 is a perspective, cross-sectional view of a loudspeaker 105 while FIG. 2 is a cross-sectional view of the loudspeaker 105 within a box 170. The loudspeaker 105 may include a magnet 110, a back plate 185, a top plate 190, a pole piece 125, and a voice coil assembly 115. A magnetic gap 165 may be defined between the top plate 190 and pole piece 125 and the gap 165 may receive the voice coil assembly 115. The top plate 190, back plate 185, and pole piece 125 may direct the magnetic field of the permanent magnet 110, thus generating a radial magnetic field in the magnetic gap 165. The voice coil assembly 115 may comprise of a wire such as an insulated copper wire 130 (i.e., voice coil or coil) wound on a coil former 115 with the two ends 140 forming the electrical leads of the voice coil 130. The voice coil 130 may be centered with the magnetic gap 165. The two ends 140 of the voice coil wire 130 may be configured to receive a signal from an amplifier (not shown). This signal may create an electrical current within the voice coil 130. The magnetic field in the magnetic gap 165 may interact with the current carrying voice coil 130 thereby generating a force. The resulting force may cause the voice coil 130 to move back and forth and consequently displace the cone from its rest position. The motion of a speaker cone 150 moves the air in front of the cone, creating sound waves, thus acoustically reproducing the electrical signal.

The loudspeaker 105 includes the speaker cone (or diaphragm) 150 extending radially outward from the coil 130 creating a conical or dome-like shape. The cone 150 may be produced from a variety of materials including but not limited to plastic, metal, paper, composite material, and any combination thereof. An opening 135 may be defined at the center of the cone 150 and a dust cap 145 may create a dome-like cover at the opening 135. The outer edge of cone 150 may be attached to the frame 155 by a surround 160. The center of the cone 150 near the voice coil 130 may be held in place by a spider 175 as shown in FIG. 2. The spider 175 and surround 160 together generally allow only for axial movement of the speaker cone 150. The frame 155 may be a conical casing that maintains the cone 150 in a fixed position, as shown in FIG. 1. The frame 155 may surround the cone 150 and be made of a more rigid material to help maintain the shape and placement of the cone 150 during operation.

During operation, and while the electrical current is being driven through the coil 130, the coil 130 may move laterally along the pole piece 125. This movement of the coil 130 may in turn cause movement of the cone 150 (i.e., cone excursion). The cone excursion or displacement x, in general, is the distance that the cone 150 moves from a rest position. The distance from the rest position varies as the magnitude of the electric signal supplied to the coil 130 changes. For example, the coil 130, upon receiving an electronic signal with a large voltage, may cause the coil 130 to move out of or further into the magnetic gap 165, as indicated by x in FIG. 2. When the coil 130 moves in and out of the magnetic gap 165, the cone 130 may be displaced from the cone's rest position. Thus, a large voltage may create a large cone excursion which in turn causes the non-linearities inherent in the transducer 105 to become dominant. Due to such non-linearities, the typical linear model used to estimate cone displacement x may result in an erroneous estimate.

As the excursion or displacement of the cone x increases, the surround 160 and spider 175 may become progressively stiffer. Due to the increasing stiffness, more force, and consequently larger input power may be required to further increase the excursion of the cone. Furthermore, as the cone moves into the enclosure, the air inside the box 170 may be compressed and may act as a spring thereby increasing the total stiffness Kₜₒₜ(x) of the spider 175 and surround 160. Thus, the displacement dependent total stiffness Kₜₒₜ(x) of the loudspeaker 105 may comprise of the stiffness of the spider K_{spider}(x), stiffness of the surround K_{surround}(x), and the stiffness of the air Kₐᵢᵣ. The stiffness of the air Kₐᵢᵣ may include the resistance that the air creates at the cone 150.

Additionally or alternatively, the inductance of the coil 130 may also be affected by the electronic signal. For example, if the positive voltage of the electronic signal is so large that the coil 130 moves out of the magnetic gap 165, the inductance of the coil 130 may be decreased. On the other hand, if the negative voltage of the electronic signal is so large that the coil 130 moves into the magnetic gap 165, the inductance of the coil 130 may increase. The variation of the inductance of the voice coil 130 represents the displacement dependent nonlinear behavior of the inductance, Lₑ(x). The inductance of the coil 130 may also be affected by current being driven through the voice coil 130. As a large negative current is driven through the coil 130, the inductance of the coil 130 may decrease.

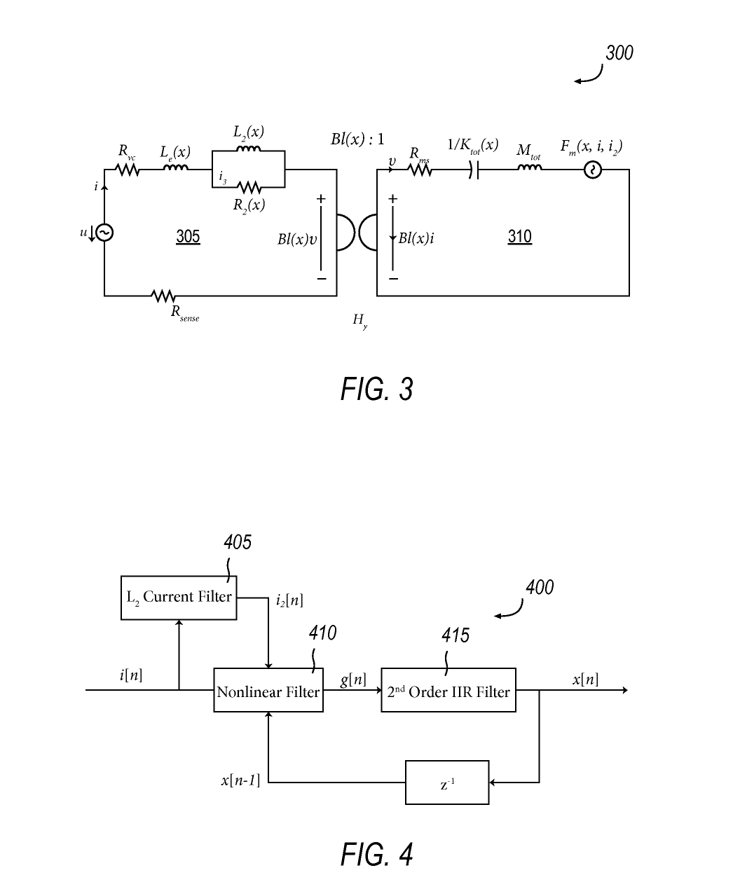

The coupling between the electrical and mechanical parts of a loudspeakers is performed by the force factor, Bl(x) which is determined by the strength of the magnetic field B within the magnetic gap 165 and length, l(x) of the coil 130 within the magnetic gap 165. As the force factor depends on the length of the coil 130 within the magnetic gap 165, the force factor may decrease as the coil 130 moves into and out of the magnetic gap 160. A large excursion of the cone 150 may decrease the force factor thereby requiring a larger input power to generate the same force on the speaker cone 150. This displacement dependent behavior of the force factor of the loudspeaker contributes to the nonlinearities in the speaker 105. FIG. 3 is an exemplary lumped parameter model or speaker model (“model”) 300 for a closed-box direct radiating loudspeaker 105. Although the examples herein are described as relating to a speaker 105, the model 300 may also benefit other transducers such as microphones. The model 300 may include an electrical circuit 305 and a mechanical circuit 310. The mechanical circuit 310 and electrical circuit 305 may be connected together via a gyrator, Hy. The gyrator is configured to cross-couple the current in the electrical circuit 305 to a force in the mechanical circuit 310. The voltage in the electrical circuit 305 may be coupled to the velocity in the mechanical circuit 310. The various linear and non-linear components shown in the parameter model 300 may be used to determine an estimated cone displacement x of the cone. Each of the components are represented by a variable as follows:
i Voice Coil current.
u AC voltage input to the voice coil.
x Displacement of the diaphragm/cone.
v Velocity of the diaphragm during displacement, where the velocity is the rate of change of displacement v=dx/dt.
f Force on the diaphragm due to the current through the voice coil, where f=Bl(x)*i.
p Sound Pressure at the diaphragm due to the motion of the cone.
R_{vc} Electrical voice coil resistance.
Lₑ Voice coil inductance.
L₂ Parasitic inductance (para-inductance) associated with Lₑ.
R₂ Parasitic resistance (para-resistance) associated with Lₑ.
Rₘₛ Resistance that models mechanical losses.
Fₘ Estimated reluctance force in Newtons.
Kₜₒₜ(x) Displacement dependent Suspension Stiffness
Mₜₒₜ Mechanical Moving Mass, including the mass of the air in front of the diaphragm and mass of the coil assembly.
Bl(x) Displacement dependent force-factor.
i₂ Current in the Para-inductance.
i₃ Current in the Para-resistance.
Rₛₑₙₛₑ Current Sensing Resistor.
uₛₑₙₛₑ Voltage measured across Rₛₑₙₛₑ.

Additionally, Rₛₑₙₛₑ, as shown in the electrical circuit 305, may be included in the model 300 as a current sensing resistor. Rₛₑₙₛₑ may have a small value (e.g., approximately 0.10 ohms) so as to not modify the value of the voice coil current i. The voice coil current i may be determined by Ohms law using the voltage uₛₑₙₛₑ measured across Rₛₑₙₛₑ over the value of Rₛₑₙₛₑ (i.e., uₛₑₙₛₑ/Rₛₑₙₛₑ=i).

The values of Lₑ(x), L₂(x), R₂(x), Fₘ(x, i, i₂), Kₜₒₜ(x) and Bl(x) may be non-linearly dependent on the value of displacement x of the cone 130, current in the voice coil i, and current in the para-inductance i₂. The electrical circuit 305 may include various estimated transducer values, such as R_{vc}, Lₑ(x), L₂(x) and R₂(x). The para-inductance L₂(x) may vary depending on the displacement x.

Given the above variables, the below equation may be used to determine the voltage input to the voice coil, u:

$$u = {iR}_{vc} + \frac{d ( {iL}_{e} ( x ) )}{d t} + \frac{d ( {i}_{2} {L}_{2} ( x ) )}{d t} + Bl ( x ) v \qquad ( 1 )$$

The displacement dependent force-factor, Bl(x) is the force due to the current, based on Lorentz's Law, and is determined by:

$$Bl ( x ) i = {vR}_{m s} + {K}_{tot} ( x ) x + {M}_{tot} \frac{d v}{d t} + {F}_{m} ( x , i , {i}_{2} ) \qquad ( 2 )$$

The reluctant force is then calculated by:

$${F}_{m} ( x , i , {i}_{2} ) = - \frac{{i}^{2}}{2} \frac{d ( {L}_{e} ( x ) )}{d x} - \frac{{i}_{2}^{2}}{2} \frac{d ( {L}_{2} ( x ) )}{d x} \qquad ( 3 )$$

Substituting equation (3) into equation (2), an implicit relationship between the voice coil current i, and the cone displacement x is derived:

$$Bl ( x ) i = {vR}_{m s} + {K}_{tot} ( x ) x + {M}_{tot} \frac{d v}{d t} + - \frac{{i}^{2}}{2} \frac{d ( {L}_{e} ( x ) )}{d x} - \frac{{i}_{2}^{2}}{2} \frac{d ( {L}_{2} ( x ) )}{d x} \qquad ( 4 )$$

Equations 4 above shows the relationship of the voice coil current i to the displacement x. Since equation 4 is an implicit equation, the current and displacement dependent variables may not be separated. Because these equations represent an algebraic loop, in order to implement the equations in a digital signal processor (DSP), a digital loop and delay elements may be used. That is, if the displacement x is determined at time t=t−1, and current i is measured at time t=t, then the displacement x at time t=t may be determined.

By rearranging equation 4 and rewriting Kₜₒₜ(x)x=(Kₜₒₜ(x)−K_{tot,0})x+K_{tot,0}x, the nonlinear terms can be separated from the linear terms:

$$Bl ( x ) i - ( {K}_{tot} ( x ) - {K}_{tot , 0} ) x + \frac{{i}^{2}}{2} \frac{d ( {L}_{e} ( x ) )}{d x} + \frac{{i}_{2}^{2}}{2} \frac{d ( {L}_{2} ( x ) )}{d x} = ( {M}_{tot} \frac{{d}^{2} ( x )}{d {t}^{2}} + {R}_{m s} \frac{d x}{d t} + {K}_{tot , 0} x ) \qquad ( 5 )$$

where K_{tot,0}=Kₜₒₜ(x=0) i.e., the value of Kₜₒₜ(x) at x=0, the rest position.

Let the left hand side of equation 5 denote a time varying signal g(t) as:

$$g ( t ) = Bl ( x ) i - ( {K}_{tot} ( x ) - {K}_{tot , 0} ) x + \frac{{i}^{2}}{2} \frac{d ( {L}_{e} ( x ) )}{d x} + \frac{{i}_{2}^{2}}{2} \frac{d ( {L}_{2} ( x ) )}{d x} \qquad ( 6 )$$

Equation 6 can be evaluated if the values of displacement x(t−1), current i(t), and para-inductance i₂(t) are known. The para-inductance current i₂ cannot be measured directly however, it may be determined from i(t) and x(t−1). In order to determine i₂, Kirchoff's current and voltage laws are applied:

$$\begin{matrix}i = {i}_{2} + {i}_{3} & ( 7 ) \\ {i}_{3} {R}_{2} ( x ) = \frac{d ( {i}_{2} {L}_{2} ( x ) )}{d t} & ( 8 ) \\ \frac{d ( {i}_{2} {L}_{2} ( x ) )}{d t} = {i}_{2} \frac{d ( {L}_{2} ( x ) )}{d t} v + {L}_{2} ( x ) \frac{d {i}_{2}}{d t} & ( 9 )\end{matrix}$$

Equations (7) and (8) are substituted into (9) to produce:

$$i = {i}_{2} ( 1 + \frac{v}{{R}_{2} ( x )} \frac{d ( {L}_{2} ( x ) )}{d x} ) + \frac{{L}_{2} ( x )}{{R}_{2} ( x )} \frac{d {i}_{2}}{d t} \qquad ( 10 )$$

Equation (10) may be converted into a discrete time-varying linear filter using bilinear transforms and be used to calculate i₂ from i. Additionally or alternatively, the above equation may also be solved using a fourth order Runge-Kutta method to obtain i₂, The value of i₂ may then be used in equation (6) to obtain the value of g(t) at time t.

To convert g(t) into displacement signal x(t), equation (6) is substituted into equation (5) to get equation (11) which shows the explicit relation between the time varying signal g(t) and displacement x(t),

$$g ( t ) = ( {M}_{tot} \frac{{d}^{2} ( x ( t ) )}{d {t}^{2}} + {R}_{m s} \frac{d x ( t )}{d t} + {K}_{tot , 0} x ( t ) ) \qquad ( 11 )$$

The Laplace transform of equation 11 is taken, resulting in:

$$\frac{X ( s )}{G ( s )} = \frac{1}{{M}_{tot} {s}^{2} + {R}_{m s} s + {K}_{tot , 0}} \qquad ( 12 )$$

The above transfer function can be converted into the discrete-time domain by taking the bilinear transform with the pre-warping frequency as the resonant frequency of the transducer. Alternatively, equation 11 can also be directly solved using the Runge-Kutta method.

For instance, the bilinear transform may be given as:

$$S = \frac{2}{T} * \frac{1 - {z}^{- 1}}{1 + {z}^{- 1}} \qquad ( 13 )$$

where T, is the sampling period and z⁻¹ denotes a delay element. For the sake of simplicity let T=1. Therefore substituting equation (13) into equation (12) and simplifying we get:

$$\frac{X ( z )}{G ( z )} = \frac{1 + 2 {z}^{- 1} + {z}^{- z}}{\begin{matrix}( 4 {M}_{tot} + 2 {R}_{m s} + {K}_{tot , 0} ) + \\ ( 2 {K}_{tot , 0} - 8 {M}_{tot} ) {z}^{- 1} + ( 4 {M}_{tot} - 2 {R}_{m s} + {K}_{tot , 0} ) {z}^{- 2}\end{matrix}} \qquad ( 14 )$$

Equation (14) represents the transfer function of an 2nd order IIR filter. Furthermore, let a=(4Mₜₒₜ+2Rₘₛ+K_{tot,0}), b=(2K_{tot,0}−8Mₜₒₜ), and c=(4Mₜₒₜ−2Rₘₛ+K_{tot,0}) substituting a, b, and c in equation 14 and rearranging we get:

$$X ( z ) = \frac{1}{a} ( G ( z ) + 2 G ( z ) {z}^{- 1} + G ( z ) {z}^{- 2} - bX ( z ) {z}^{- 1} - cX ( z ) {z}^{- 2} ) \qquad ( 15 )$$

Taking the inverse z-transform:

$$x [ n ] = \frac{1}{a} ( g [ n ] + 2 g [ n - 1 ] + g [ n - 2 ] - bx [ n - 1 ] - cx [ n - 2 ] ) \qquad ( 16 )$$

Thus, the measured current can be converted into an estimate of displacement x using this discrete domain transfer function. Further, a displacement x may be determined based on the voice coil current i. The above analysis determines an estimated displacement x based on the current of the voice coil i, the coil stiffness Kₘₛ, the voice coil inductance Lₑ, the voice-coil para-inductance L₂, and the force factor Fₘ. Specifically, the contribution of the voice coil para-inductance L₂ of the reluctance force Fₘ and voice coil para-resistance R₂ are used in determining an estimated displacement x.

FIG. 4 is a block diagram 400 of the model 300 of FIG. 3. The block diagram and labels thereof are shown in the discrete-time domain while some of the equations above are shown in the continuous-time domain. The equations above may be converted into discrete-time domain by taking the bilinear transform. The pre-warping frequency may be the resonant frequency of the transducer. The resonant frequency of the transducer is the frequency at which the SPL output of the transducer is maximum for a given input voltage. This may be described as:

$${F}_{s} = \frac{\sqrt{{K}_{tot , 0}}}{2 π \sqrt{{M}_{tot}}} \qquad ( 15 )$$

Block 405 may be a current filter configured to or programmed to apply equation (10) above to determine i₂ based on i. Block 410 may be a non-linear filter configured to apply equation (6) above to determine the discrete time varying signal g[n] based on i₂[n] and i[n]. Block 415 may be a second order infinite impulse response (IIR) filter configured to apply equation (11) to determine the displacement x[n] based on g[n]. The value of x[n−1] is used to compute the nonlinear variables in equation 6 and equation 10.

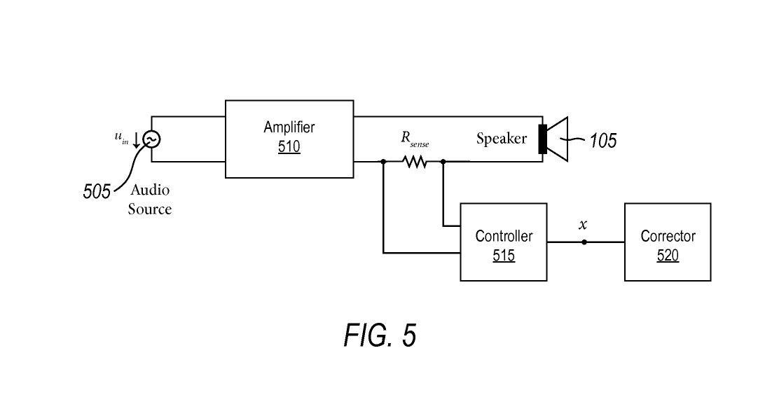

FIG. 5 is an audio system 500 including an audio source 505 that is configured to transmit an audio signal to an amplifier 510 and a loudspeaker 105. A controller 515 may be in communication with a resistor Rₛₑₙₛₑ at the loudspeaker 105. The controller may have a processor and a memory for executing instructions to execute the equations and methods described herein. In generally, the controller 515 is programmed to execute the various equations as noted herein. The controller 515 may include the model of FIG. 3 and may output the estimated cone displacement x to a corrector 520. The controller 515 may modify the audio signal based on the displacement x and make necessary adjustments to the audio signal based on the same. The corrector 520 may be a non-linear corrector. The corrector 520 may be developed based on the displacement x. The corrector 520 may be a separate processor having a controller and a memory. Although shown as a separate component in FIG. 5, the corrector 520 may also be included and developed in controller 515.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

Computing devices described herein generally include computer-executable instructions, where the instructions may be executable by one or more computing or hardware devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

What is claimed is:

1. A displacement estimation system for estimating cone displacement of a loudspeaker, comprising:
an electrical circuit including at least one non-linear component being coupled to a mechanical circuit including at least one non-linear component, and
a controller programmed to:
determine the cone displacement of the loudspeaker based on the at least one non-linear component by using a discrete domain transfer function of a measured current of the electrical circuit, and
transmit the displacement to a corrector to correct distortion of an audio signal due to the displacement.

2. The system of claim 1, wherein the at least one non-linear component includes at least one of a para-inductance and para-resistance.

3. The system of claim 2, wherein the controller is further programmed to determine the cone displacement based on a voice coil current.

4. The system of claim 3, wherein the controller is further programmed to determine a para-inductance current based on the voice coil current.

5. The system of claim 4, wherein the controller is further programmed to convert the voice coil current into the cone displacement using a discrete domain transfer function.

6. The system of claim 2, wherein the controller is further programmed to determine the cone displacement based on a velocity of the cone displacement.

7. The system of claim 1, wherein the at least one non-linear component includes a stiffness for a suspension of the loudspeaker and wherein the suspension includes at least one of a surround and a spider.

8. The system of claim 7, wherein the stiffness of the suspension includes at least one of a surround stiffness, a spider stiffness and an air stiffness, the suspension stiffness being displacement dependent.

9. An audio system comprising:
a loudspeaker including a cone and a parameter model; and
a controller electrically coupled to the loudspeaker and being programmed to determine a cone displacement of the cone based on at least one non-linear component of a speaker model using a discrete domain transfer function of a measured current of the speaker model.

10. The system of claim 9, wherein the at least one non-linear component includes at least one of a para-inductance and para-resistance.

11. The system of claim 10, wherein the controller is further programmed to the cone displacement based on a voice coil current.

12. The system of claim 11, wherein the controller is further programmed to determine a para-inductance current based on the voice coil current.

13. The system of claim 12, wherein the controller is further programmed to convert the voice coil current into the cone displacement via a discrete domain transfer function.

14. The system of claim 12, wherein the model includes an electrical circuit coupled to a mechanical circuit via a gyrator, the at least one of a para-inductance and para-resistance included in the electrical circuit.

15. The system of claim 9, wherein the at least one non-linear component includes a suspension stiffness including the stiffness.

16. The system of claim 15, wherein the suspension stiffness includes at least one of a surround stiffness, a spider stiffness and an air stiffness, the suspension stiffness being displacement dependent.

17. A displacement estimation system for estimating cone displacement of a loudspeaker, comprising:
a controller programmed to determine the cone displacement of the loudspeaker based on at least one non-linear component by using a discrete domain transfer function of a measured current of an electrical circuit of a speaker model, wherein the displacement is transmitted to a corrector to correct distortion of an audio signal due to the displacement.

18. The system of claim 17, wherein the at least one non-linear component includes at least one of a para-inductance and para-resistance.

19. The system of claim 18, wherein the controller is further programmed to determine the cone displacement based on a voice coil current.

20. The system of claim 19, wherein the controller is further programmed to determine a para-inductance current based on the voice coil current.
